(19) United States
(12) Patent Application Publication
(10) Pub. No.: US 2012/0177903 A1
(43) Pub. Date: Jul. 12, 2012

(54) MULTILAYER COATING, METHOD FOR FABRICATING A MULTILAYER COATING, AND USES FOR THE SAME

(75) Inventors: Sami Sneck, Vantaa (FI); Nora Isomäki, Espoo (FI); Jarmo Maula, Espoo (FI); Olli Jylhä, Espoo (FI); Matti Putkonen, Espoo (FI); Runar Törnqvist, Helsinki (FI); Mikko Söderlund, Helsinki (FI)

(73) Assignee: Beneq Oy, Vantaa (FI)

(21) Appl. No.: 13/395,942

(22) PCT Filed: Sep. 13, 2010
(86) PCT No.: PCT/FI2010/050700

§ 371 Date: Mar. 14, 2012

(30) Foreign Application Priority Data
Sep. 14, 2009 (FI) 20095947

(51) Int. Cl. B32B 7/02; B32B 9/00; B05D 1/36; B82Y 40/00

(52) U.S. Cl. 428/216; 427/419.3; 428/702; 977/890

(57) ABSTRACT

A multilayer coating and a method for fabricating a multilayer coating on a substrate (3). The coating is arranged to minimize diffusion of atoms through the coating, the method comprising the steps of introducing a substrate (3) to a reaction space, depositing a layer of first material (1) on the substrate (3), and depositing a layer of second material (2) on the layer of first material (1). Depositing the layer of first material (1) and the layer of second material (2) comprises alternately introducing precursors into the reaction space and subsequently purging the reaction space after each introduction of a precursor. The first material being selected from the group of titanium oxide and aluminum oxide, the second material being the other from the group of titanium oxide and aluminum oxide. An interfacial region is formed in between titanium oxide and aluminum oxide.a.

### FIELD OF THE INVENTION

The present invention relates to film deposition technology. Especially the present invention relates to multilayer coatings, methods for their fabrication, and uses for the same.

### BACKGROUND OF THE INVENTION

Barrier coatings are commonly used to protect an underlying substrate from the surrounding environment. Many barrier coating are especially used as chemical barriers which protect the substrate by preventing or minimizing diffusion of a chemically active species from the environment through the barrier coating and onto the surface of the substrate. These chemical barrier coatings, often referred to as diffusion barriers, have been developed against many different potentially reactive species. Diffusion barriers exist against, for example, water, oxygen, various acids and toxic chemicals.

The performance of the diffusion barrier against a specific material depends on e.g. the material of the coating, the thickness of the coating and the quality of the coating which is significantly affected by the fabrication method used to deposit or to otherwise form the coating on the substrate.

Diffusion barrier coatings known from the prior art fall short in their performance, i.e. in their ability to minimize diffusion of a specific species through the coating, for several reasons. An important reason is that many known barrier coatings are fabricated using methods which result in films including different types of defects such as pinholes, pores or cracks, or even dislocations in crystallized material. These defects generate routes through which diffusion can efficiently occur. Methods resulting in such defective coatings include e.g. chemical vapour deposition (CVD), physical vapour deposition (PVD), various aerosol based methods and sputtering. For example US patent application publication 2008/0006819A1 teaches the fabrication of moisture barriers using PECVD. Although process parameters can naturally be optimized in the aforementioned methods to reduce the density of the defects the growth mechanism of the coating in the methods makes is difficult to obtain coatings with a quality suitable for efficient diffusion barriers.

Many of the known diffusion barrier coatings comprise layers of different materials on top of each other to form a multilayer structure. In these multi-layer diffusion barriers the layers of different materials commonly impart different functions to the coating. When fabricated with the aforementioned methods, the problem of defective films still remains. Examples of multilayer coatings used as a diffusion barrier can be found in U.S. Pat. No. 5,607,789 and US patent application publication 2008/0006819A1.

### PURPOSE OF THE INVENTION

A purpose of the present invention is to reduce the aforementioned technical problems of the prior-art by providing a new type of multilayer coating a new type of method for fabricating the multi-layer coating and uses for the same.

### SUMMARY OF THE INVENTION

The method according to the present invention is characterized by what is presented in independent claim 1.

The product according to the present invention is characterized by what is presented in independent claim 13.

The use according to the present invention is characterized by what is presented in independent claim 26 or 27.

The method according to the present invention is a method for fabricating a multilayer coating on a substrate, the coating being arranged to minimize diffusion of atoms through the coating. The method comprises the steps of introducing a substrate to a reaction space, depositing a layer of first material on the substrate, and depositing a layer of second material on the layer of first material. Depositing the layer of first material comprises the steps of, introducing a first precursor into the reaction space such that at least a portion of the first precursor adsorbs onto the surface of the substrate and subsequently purging the reaction space, and introducing a second precursor into the reaction space such that at least a portion of the second precursor reacts with the first precursor adsorbed onto the surface of the substrate and subsequently purging the reaction space. Depositing the layer of second material comprises the steps of, introducing a third precursor into the reaction space such that at least a portion of the third precursor adsorbs onto the surface of the layer of first material and subsequently purging the reaction space, and introducing a fourth precursor into the reaction space such that at least a portion of the fourth precursor reacts with the third precursor adsorbed onto the surface of the layer of first material and subsequently purging the reaction space. The first material is selected from the group of titanium oxide and aluminum oxide, and the second material is the other from the group of titanium oxide and aluminum oxide. An interfacial region is formed in between titanium oxide and aluminum oxide.

A multilayer coating on a substrate, according to the present invention, is arranged to minimize diffusion of atoms through the coating. The coating comprises a layer of first material on the substrate, and a layer of second material on the layer of first material. The first material is selected from the group of titanium oxide and aluminum oxide, the second material being the other from the group of titanium oxide and aluminum oxide. The multilayer coating comprises an interfacial region in between titanium oxide and aluminum oxide.

According to the present invention the method of the present invention is used to fabricate a multi-layer coating on a substrate, to minimize diffusion of water from the environment through the coating onto the surface of the substrate.

According to the present invention the multi-layer coating of the present invention is used on a substrate, to minimize diffusion of water from the environment through the coating onto the surface of the substrate.

The present invention provides a multilayer coating which efficiently minimizes diffusion of material, i.e. atomic or molecular diffusion, onto a substrate from the environment through the multilayer coating. In this particular context the word “environment” should be understood as the region on the opposite side of the coating as viewed from the side of the substrate.

The present invention also provides a multi-layer coating, which efficiently minimizes diffusion of such material that has traversed the substrate, through the multilayer coating (e.g. barrier-on-foil embodiment). I.e. the multilayer coating according to the invention minimizes diffusion of material through the coating regardless of the direction from which the material is heading towards the coating.

According to one embodiment of the invention the coating is fabricated by depositing the layer of first material by introducing a first precursor into a reaction space such that at least a portion of the first precursor adsorbs onto the surface of the substrate and subsequently purging the reaction space, and introducing a second precursor into the reaction space such that at least a portion of the second precursor reacts with the first precursor adsorbed onto the surface of the substrate and subsequently purging the reaction space; depositing the layer of second material by introducing a third precursor into the reaction space such that at least a portion of the third precursor adsorbs onto the surface of the layer of first material and subsequently purging the reaction space, and introducing a fourth precursor into the reaction space such that at least a portion of the fourth precursor reacts with the third precursor adsorbed onto the surface of the layer of first material and subsequently purging the reaction space.

It has surprisingly been found that a multi-layer structure comprising a layer of titanium oxide and a layer of aluminum oxide in contact with each other efficiently reduces material diffusion through the structure. When additionally the titanium oxide and the aluminum oxide layers are deposited by alternately introducing at least two different precursors into the reaction space such that at least a portion of the introduced precursor adsorbs onto the deposition surface, the barrier performance of the multi-layer coating is further enhanced, i.e. material diffusion through the coating is reduced.

The observed advantages are achieved since aluminum oxide and titanium oxide form an interfacial region in between the two materials. This interfacial region possesses a structure which efficiently prevents material diffusion through the aluminum oxide and titanium oxide interface. According to one embodiment of the invention the chemical composition changes in the interfacial region in between titanium oxide and aluminum oxide. According to one embodiment of the invention the interfacial region comprises an aluminate phase of titanium oxide and aluminum oxide. The aluminate phase is thermodynamically more stable than the single layers of titanium oxide and aluminum oxide. According to one embodiment of the invention a densification occurs at the interfacial region of titanium oxide and aluminum oxide providing a reduction in the diffusion of atoms through the multilayer coating. Furthermore, the surface governed growth mechanism resulting from the alternating adsorption of precursors leads to dense films with only a negligible amount of pores or pinholes, which increases the density of the titanium oxide and aluminum oxide layers. This leads to an additional reduction in the diffusion of atoms through the multilayer coating.

According to one embodiment of the invention the method comprises the step of depositing another layer of first material onto a layer of second material, to form a second interfacial region between titanium oxide and aluminum oxide. According to another embodiment of the invention the coating comprises another layer of first material on a layer of second material, to form a second interfacial region between titanium oxide and aluminum oxide. As is compatible with the aforementioned it has been observed that forming a multilayer coating having a second interfacial region between a layer of aluminum oxide and a layer of titanium oxide further reduces the diffusion of atoms through the multilayer coating.

According to one embodiment of the invention the method comprises forming two or more interfacial regions in the multilayer coating. According to one embodiment of the invention the multilayer coating comprises two or more interfacial regions. An advantage of the two or more interfacial regions is the further reduction of diffusion of atoms through the multilayer coating.

According to one embodiment of the invention the second material is titanium oxide. Long term durability of the multilayer barrier coating against weather or against other potentially harsh and/or chemically aggressive environmental conditions can be improved by ensuring that the coating comprises a section where a layer of titanium oxide resides on a layer of aluminum oxide, i.e. a layer of titanium oxide resides closer to the above environment than a layer of aluminum oxide. Again, without limiting the invention to any theoretical speculation, in this embodiment of the invention a titanium oxide layer protects chemically an underlying aluminum oxide layer which then imparts the good diffusion barrier properties on the multilayer coating. I.e. the titanium oxide layer acts as a resilient material against chemicals from the environment. This enables an aluminum oxide layer having good barrier properties under the titanium oxide layer to better maintain its structure, which prolongs the lifetime of the multilayer coating.

According to one embodiment of the invention a layer of titanium oxide is deposited by selecting the first precursor or the third precursor from the group of water and titanium tetrachloride, while the second precursor or the fourth precursor are the other from the group of water and titanium tetrachloride, respectively. According to another embodiment of the invention a layer of aluminum oxide is deposited by selecting the first precursor or the third precursor from the group of water and trimethylaluminum, while the second precursor or the fourth precursor are the other from the group of water and trimethylaluminum, respectively. Titanium tetrachloride and water are precursors which can be used to deposit titanium oxide such that the growth of the titanium oxide layer occurs essentially through chemical surface reactions on the deposition surface. Correspondingly trimethylaluminum and water are precursors which can be used to deposit aluminum oxide such that the growth of the titanium oxide layer occurs essentially through chemical surface reactions on the deposition surface. Under suitable process condition, discussed later, these surface reactions can be made essentially self-limiting, which results in very conformal, uniform and dense films. The process chemistry in these embodiments of the invention enables deposition of the multilayer coating with excellent diffusion barrier properties even over non-planar three-dimensional substrates having a surface with a complex geometry.

According to one embodiment of the invention the method comprises depositing a layer of first material having suitably a thickness of below 25 nanometers and preferably a thickness of below 10 nanometers, and a layer of second material having suitably a thickness of below 25 nanometers and preferably a thickness of below 10 nanometers. According to one embodiment of the invention a layer of first material has suitably a thickness of below 25 nanometers and preferably a thickness of below 10 nanometers, and a layer of second material has suitably a thickness of below 25 nanometers and preferably a thickness of below 10 nanometers. The method according to the present invention enables using surprisingly thin aluminum and titanium oxide layers without compromising the barrier properties of the multilayer coating. Therefore, as the thin layers in the multilayer structure according to the present invention results in significantly better diffusion barrier properties than a single layer of aluminum oxide or titanium oxide with an equivalent physical thickness, the multilayer coating and the method for its formation can be realized cost efficiently in a simple and rapid process with only minimal consumption of precursor materials. Additionally, suitable inexpensive precursor materials for fabricating the multilayer coating of the present invention, such as the aforementioned trimethylaluminum, water (or de-ionized water) and titanium tetrachloride, are readily available.

According to one embodiment of the present invention the method comprises depositing at a temperature not more than 150° C. According to another embodiment of the present invention the method comprises depositing at a temperature not more than 100° C.

According to one embodiment of the invention the multilayer coating is fabricated at a depositing temperature not more than 150° C. According to another embodiment of the invention the multilayer coating is fabricated at a depositing temperature not more than 100° C.

According to one embodiment of the invention the multilayer coating is fabricated on a moisture-permeable substrate. According to one embodiment of the invention the method comprises fabricating a multilayer coating on a substrate comprising a moisture sensitive device. According to one embodiment of the invention the method comprises fabricating a multilayer coating on a substrate comprising polymer. According to one embodiment of the invention the substrate comprises a moisture sensitive device. According to one embodiment of the invention the substrate comprises polymer. LED and OLED are mentioned as examples of a moisture sensitive device. According to one embodiment of the invention the polymer is selected from a group consisting of polyethylene naphthalate (PEN), polyethylene terephthalate (PET), polypropylene (PP), and nylon. According to one embodiment the invention is used for a substrate comprising polymer. According to one embodiment the invention is used for a substrate comprising a moisture sensitive device.

According to one embodiment of the invention titanium oxide and aluminum oxide are in amorphous form.

The present invention provides, according to one embodiment, glasslike moisture-barrier properties for a polymer coating (i.e. barrier-on-foil).

The embodiments of the invention described hereinbefore may be used in any combination with each other. Several of the embodiments may be combined together to form a further embodiment of the invention. A method, a product, or a use, to which the invention is related, may comprise at least one of the embodiments of the invention described hereinbefore.

### DETAILED DESCRIPTION OF THE INVENTION

In the following, the present invention will be described in more detail with exemplary embodiments by referring to the accompanying figures, in which

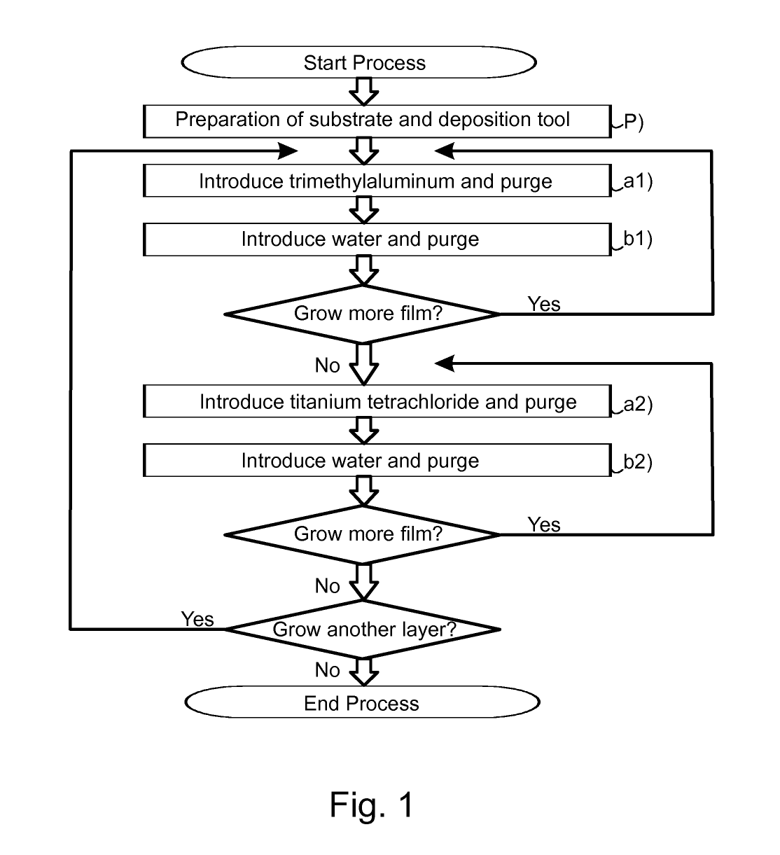

FIG. 1 is a flow-chart illustration of a method according to one embodiment of the present invention,

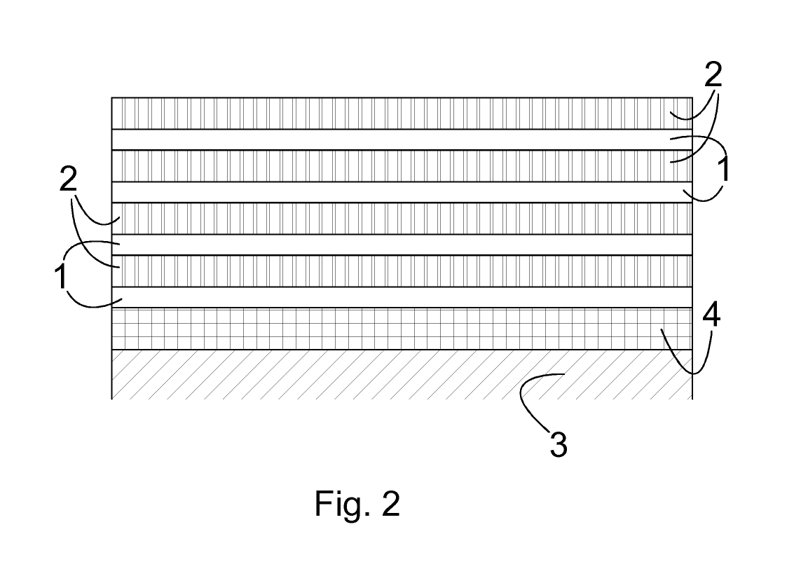

FIG. 2 is a schematic illustration of a multilayer coating according to one embodiment of the present invention, and

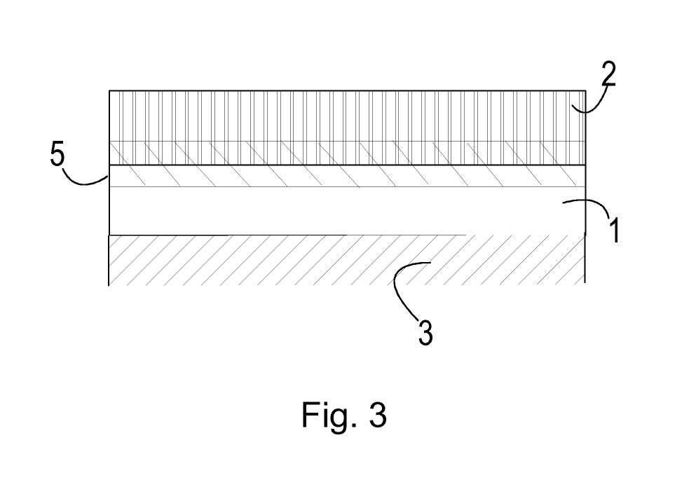

FIG. 3 is a schematic illustration of a multilayer coating according to one embodiment of the present invention.

Atomic Layer Deposition (ALD) is a method which can be used for depositing uniform and conformal thin-films over substrates of various shapes, even over complex 3D (three dimensional) structures. In ALD the coating is grown by alternately repeating, essentially self-limiting, surface reactions between a precursor and a surface to be coated. Therefore the growth mechanism in an ALD process enables coating without directional effects like in coating methods relying on rapid gas-phase reactions, such as metal-organic chemical vapour deposition (MOCVD), or without line of sight effects observed in physical vapour deposition (PVD).

In an ALD process two or more different chemicals (precursors) are introduced to a reaction space in a sequential, alternating, manner and the precursors adsorb on surfaces, e.g. on a substrate, inside the reaction space. The sequential, alternating, introduction of precursors is commonly called pulsing (of precursors). In between each precursor pulse there is commonly a purging period during which a flow of inert gas, often called the carrier gas, purges the reaction space from e.g. surplus precursor and by-products resulting from reactions between the deposition surface and the precursor. A film can be grown by an ALD process by repeating several times a pulsing sequence comprising the aforementioned precursor pulses and purging periods. The number of how many times this sequence called the “ALD cycle” is repeated depends on the targeted thickness of the film, or coating.

The description below discloses some embodiments of the invention in such a detail that a person skilled in the art is able to utilize the invention based on the disclosure. Not all steps of the embodiments are discussed in detail, as many of the steps will be obvious for the person skilled in the art based on this specification.

For example, the construction of a processing tool suitable for carrying out the methods in the following embodiments will be obvious for the skilled person. The tool can be e.g. a conventional ALD tool suitable for handling the chemicals discussed below. ALD tools (i.e. reactors) are disclosed in e.g. U.S. Pat. No. 4,389,973 and U.S. Pat. No. 4,413,022 which are included herein as references. Many of the steps related for handling such tools, such as delivering a substrate into the reaction space, pumping the reaction space down to a low pressure, heating the substrates and the reaction space etc., will be obvious for the skilled person. Also, many other known operations or features are not described in detail nor mentioned, in order to emphasize relevant aspects of the various embodiments of the invention.

An embodiment of the present invention presented by the flow-chart of FIG. 1 begins by bringing the substrate 3 into the reaction space (step P)) of a typical reactor tool, e.g. a tool suitable for carrying out an ALD process. The reaction space is subsequently pumped down to a pressure suitable for forming the film using e.g. a mechanical vacuum pump. The substrate 3 is also heated to a temperature suitable for forming the film by the used method. The substrate 3 can be introduced to the reaction space through e.g. an airtight load-lock system or simply through a loading hatch. The substrate 3 can be heated by e.g. resistive heating elements which also heat the entire reaction space. Step P) may also include other preparation procedures which depend on the reactor tool, on the overall process, or on the environment in which the tool is operated. For example the substrate 3 may be coated with a film of other material 4 or the surface of the substrate 3 may be otherwise treated with or exposed to chemicals. These procedures will be obvious for the skilled person in light of this specification.

After the substrate 3 and the reaction space have reached the targeted temperature and other conditions suitable for deposition the alternate introduction of precursors into the reaction space and onto the surface of the substrate 3 is started. The surface of the substrate 3 is preferably exposed to precursors in their gaseous form. This can be realized by first evaporating the precursors in their respective source containers which may or may not be heated depending on the properties of the precursor itself. The evaporated precursor can be delivered into the reaction space by e.g. dosing it through the pipework of the reactor tool comprising flow channels for delivering the vaporized precursors into the reaction space. Controlled dosing of vapour into the reaction space can be realized by valves installed in the flow channels. These valves are commonly called pulsing valves in an ALD system. Also other mechanisms of bringing the substrate 3 into contact with a precursor inside the reaction space may be conceived. One alternative is to make the surface of the substrate 3 (instead of the vaporized precursor) move inside the reaction space such that the substrate 3 moves through a region occupied by gaseous precursor.

A typical ALD reactor also comprises a system for introducing inert gas, such as nitrogen or argon into the reaction space such that the reaction space can be purged from surplus precursor and reaction by-products before introducing the next precursor into the reaction space. This feature together with the controlled dosing of vaporized precursors enables alternately exposing the surface to precursors without significant intermixing of different precursors in the reaction space or in other parts of the ALD reactor. In practice the flow of inert gas is commonly continuous through the reaction space throughout the deposition process and only the various precursors are alternately introduced to the reaction space with the inert gas. Obviously, purging of the reaction space does not necessarily result in complete elimination of surplus chemicals or reaction by-products from the reaction space but residues of these or other materials may always be present.

Following the step of various preparations (step P) discussed above), in the embodiment of the present invention illustrated in FIG. 1, step a1) is carried out in order to start the growth of the layer of first material 1 onto the substrate. In this embodiment of the invention the first material is aluminum oxide and the second material is titanium oxide. The exact composition and phase of the aluminum oxide and titanium oxide can vary. These materials may obviously also include impurities although their concentration remains relatively low as a result of the growth method.

In step a1) gaseous trimethylaluminum is introduced to the reaction space and thereby the surface of the substrate 3 is exposed to trimethylaluminum. Exposure of the surface to trimethylaluminum results, in suitable process conditions discussed below, in the adsorption of a portion of the introduced trimethylaluminum onto the surface. After purging of the reaction space from trimethylaluminum water vapor is introduced to the reaction space and thereby the surface of the substrate, which in this case has the adsorbed portion of the trimethylaluminum precursor adsorbed onto it, is exposed to water (step b1)), some of which in turn gets adsorbed onto the surface. The reaction space is subsequently purged from the water.

Thickness of the resulting aluminum oxide film on the substrate 3 can be increased by repeating the steps a1) and b1), in this order, as presented by the flow-chart of FIG. 1. In this embodiment of the invention the number of how many times the steps a1) and b1) are repeated depends on the targeted film thickness and on the growth rate of the aluminum oxide film under the specific process conditions. The targeted thickness for the layer of first material 1 in this embodiment of the invention is below 25 nanometers (nm).

After the layer of first material 1 has been grown to the desired film thickness the deposition of the layer of second material 2 is started onto the layer of first material 1. The growth of the layer of second material 2 starts with step a2), where titanium tetrachloride is introduced to the reaction space. Exposure of the surface to titanium tetrachloride results, in suitable process conditions discussed below, in the adsorption of a portion of the introduced vaporized titanium tetrachloride onto the deposition surface. After purging of the reaction space from titanium tetrachloride vaporized water is introduced to the reaction space and thereby the surface of the substrate, which in this case has the adsorbed portion of the titanium tetrachloride precursor adsorbed onto it, is exposed to water (step b2)), some of which in turn gets adsorbed onto the deposition surface. The reaction space is subsequently purged from the water.

Thickness of the resulting titanium oxide film on the aluminum oxide film can be increased by repeating the steps a2) and b2), in this order, as presented by the flow-chart of FIG. 1. In this embodiment of the invention the number of how many times the steps a2) and b2) are repeated depends on the targeted film thickness and on the growth rate of the titanium oxide film under the specific process conditions. The targeted thickness for the layer of second material 2 in this embodiment of the invention is below 25 nanometers (nm).

The embodiment of the invention presented in FIG. 1 results in a multilayer coating on a substrate 3. This coating is presented in FIG. 2, which also presents an optional layer of other material 4 which may be grown in between the substrate 3 and the multi-layer coating during the preparation step P). In the multilayer coating, a layer of titanium oxide second material 2 resides on a layer of aluminum oxide first material 1. By suitably choosing the chemicals and the process parameters utilized to deposit the layer of first material 1 and the layer of second material 2 the adsorption reactions responsible for film-growth exhibit self-limiting characteristics, and the conformality, the homogeneity and the barrier properties of the individual layers and of the whole multilayer coating can be further improved.

In FIG. 3 is presented a multilayer coating on a substrate 3 according to one embodiment of the present invention. In FIG. 3 the interfacial region 5 formed in between titanium oxide 2 and aluminum oxide 1 is presented.

The following example describes in detail how the multilayer coating can be grown on the substrate 3.

### EXAMPLE

According to the embodiment of the invention presented in FIG. 1 multilayer coatings were formed on Ca-substrates (Calcium substrates). The substrates were first inserted inside the reaction space of a P400A ALD tool (available from Beneq OY, Finland). The Ca-substrates were planar to enable reliable permeations rate measurements. In this example the inert gas discussed above and responsible for purging the reaction space was nitrogen (N₂).

In this example Ca-substrates were used. However, in an equal manner any other suitable substrate material could be used.

After preparations for loading the substrates into the ALD tool, the reaction space of the ALD tool was pumped down to the processing pressure of about 1 mbar and the substrates were subsequently heated to the processing temperature of about 100° C. The temperature was stabilized to the processing temperature inside the reaction space by a computer controlled heating period of two to four hours.

After the processing temperature was reached and stabilized, the surface of the substrate 3 was exposed to an ozone treatment and a thin conditioning layer 4 of aluminum oxide was subsequently grown from trimethylaluminum and water, on the substrate 3. After this the method moved from step P) to the step a1), according to FIG. 1. The pulsing sequence of a1) then b1) was carried out once and then repeated 53 times to form a first layer of aluminum oxide with a thickness of approximately 5 nm on the substrate. After this layer was formed the process moved to step a2) and subsequently to step b2). The pulsing sequence of a2) then b2) was carried out once and then repeated 110 times to form a layer of titanium oxide with a thickness of approximately 5 nm on the layer of first material 1 (aluminum oxide).

In this example the aforementioned structure of a 5 nm thick titanium oxide layer on a 5 nm thick aluminum oxide layer was grown ten times altogether, to form a multilayer coating consisting of the 10 layers of first material 1 and the 10 layers of second material 2. Hence, this structure comprised 19 interfaces between aluminum oxide and titanium oxide in a multilayer coating having a total thickness of only about 100 nm, which resulted in surprisingly efficient diffusion barrier properties in view of the total thickness of the layer, as will be discussed subsequently. After the growth of this multilayer coating the growth process was ended, after which heating of the reaction space was turned off and the substrates were ejected from the reaction space and from the ALD-tool.

Exposure of the surface of the substrate 3 to a specific precursor was carried out by switching on the pulsing valve of the P400 ALD-tool controlling the flow of the precursor into the reaction space. Purging of the reaction space was carried out by closing the valves controlling the flow of precursors into the reaction space, and thereby letting only the continuous flow of inert gas flow through the reaction space.

The pulsing sequence in this example for the aluminum oxide layer was in detail as follows; 0.6 s exposure to trimethylaluminum, 1.0 s purge, 0.6 s exposure to H₂O, 5 s purge. The pulsing sequence in this example for the titanium oxide layer was in detail as follows; 0.6 s exposure to titanium tetrachloride, 1.0 s purge, 0.6 s exposure to H₂O, 3 s purge. An exposure time and a purge time in this sequence signify a time a specific pulsing valve for a specific precursor was kept open and a time all the pulsing valves for precursors were kept closed, respectively. In this example the aluminum oxide and the titanium oxide layers were formed at a processing temperature of about 100° C. at which temperature the aluminum oxide layers and the titanium oxide layers grew essentially amorphous. This further helped reducing grain boundaries, dislocations and other defects mostly associated with crystalline materials.

The permeations rate for the grown multilayer coatings were measured in an environment having a relative humidity of 80% and a temperature of 80° C. The testing procedure followed the widely used “80/80”-test in which the Ca-substrate immediately reacted with water that diffused from the humid environment into contact with the Ca-substrate through the multilayer coating. The details of the “80/80”-test will be obvious for a skilled person. Results indicated a surprisingly low permeations rate for the exemplary multilayer coating. The measured value of permeation of water through the coating, i.e. the permeations rate for water, was about 0.8 g/(m²day) (grams of water through one square meter of coating in one day). The pulsing sequence and the process parameters used in the example additionally contributed to the resulting very conformal and uniform films over large areas of the substrate 3 surface and even over complex non-planar surfaces.

Although the permeations rate for the exemplary structure was measured for water, low permeations rates were observed also for other species, for e.g. oxygen, and the multilayer coatings were generally observed to minimize diffusion of atoms through the coating.

As is clear for a person skilled in the art, the invention is not limited to the examples described above but the embodiments can freely vary within the scope of the claims.

1. A method for fabricating a multilayer coating on a substrate, the coating being arranged to minimize diffusion of atoms through the coating, the method comprising the steps of introducing a substrate to a reaction space, depositing a layer of first material on the substrate, and depositing a layer of second material on the layer of first material, wherein depositing the layer of first material comprises the steps of,
introducing a first precursor into the reaction space such that at least a portion of the first precursor adsorbs onto the surface of the substrate and subsequently purging the reaction space, and
introducing a second precursor into the reaction space such that at least a portion of the second precursor reacts with the first precursor adsorbed onto the surface of the substrate and subsequently purging the reaction space;
depositing the layer of second material comprises the steps of,
introducing a third precursor into the reaction space such that at least a portion of the third precursor adsorbs onto the surface of the layer of first material and subsequently purging the reaction space, and
introducing a fourth precursor into the reaction space such that at least a portion of the fourth precursor reacts with the third precursor adsorbed onto the surface of the layer of first material and subsequently purging the reaction space;
the first material being selected from the group of titanium oxide and aluminum oxide, the second material being the other from the group of titanium oxide and aluminum oxide, and in that an interfacial region is formed in between titanium oxide and aluminum oxide.

2. The method of claim 1, wherein the method comprises the step of depositing another layer of first material onto a layer of second material, to form a second interfacial region between titanium oxide and aluminum oxide.

3. The method of claim 1, wherein the method comprises forming two or more interfacial regions in the multilayer coating.

4. The method of claim 1, wherein the second material is titanium oxide.

5. The method of claim 1, wherein a layer of titanium oxide is deposited by selecting the first precursor or the third precursor from the group of water and titanium tetrachloride, while the second precursor or the fourth precursor are the other from the group of water and titanium tetrachloride, respectively.

6. The method of claim 1, wherein a layer of aluminum oxide is deposited by selecting the first precursor or the third precursor from the group of water and trimethylaluminum, while the second precursor or the fourth precursor are the other from the group of water and trimethylaluminum, respectively.

7. The method of claim 1, wherein the method comprises depositing a layer of first material having suitably a thickness of below 25 nanometers and preferably a thickness of below 10 nanometers, and a layer of second material having suitably a thickness of below 25 nanometers and preferably a thickness of below 10 nanometers.

8. The method of claim 1, wherein the method comprises depositing at a temperature not more than 150° C.

9. The method of claim 1, wherein the method comprises depositing at a temperature not more than 100° C.

10. The method of claim 1, wherein the method comprises fabricating a multilayer coating on a substrate comprising a moisture sensitive device.

11. The method of claim 1, wherein the method comprises fabricating a multilayer coating on a substrate comprising polymer.

12. The method of claim 1, wherein titanium oxide and aluminum oxide are in amorphous form.

13. A multilayer coating on a substrate, the coating being arranged to minimize diffusion of atoms through the coating, the coating comprising a layer of first material on the substrate, and a layer of second material on the layer of first material, wherein the first material is selected from the group of titanium oxide and aluminum oxide, the second material being the other from the group of titanium oxide and aluminum oxide, and in that the multilayer coating comprises an interfacial region in between titanium oxide and aluminum oxide.

14. The multilayer coating of claim 13, the coating is fabricated by depositing the layer of first material by
introducing a first precursor into a reaction space such that at least a portion of the first precursor adsorbs onto the surface of the substrate and subsequently purging the reaction space, and
introducing a second precursor into the reaction space such that at least a portion of the second precursor reacts with the first precursor adsorbed onto the surface of the substrate and subsequently purging the reaction space;
depositing the layer of second material by
introducing a third precursor into the reaction space such that at least a portion of the third precursor adsorbs onto the surface of the layer of first material and subsequently purging the reaction space, and
introducing a fourth precursor into the reaction space such that at least a portion of the fourth precursor reacts with the third precursor adsorbed onto the surface of the layer of first material and subsequently purging the reaction space.

15. The multilayer coating of claim 13, wherein the coating comprises another layer of first material on a layer of second material, to form a second interfacial region between titanium oxide and aluminum oxide.

16. The multilayer coating of claim 13, wherein the multilayer coating comprises two or more interfacial regions.

17. The multilayer coating of claim 13, wherein the second material is titanium oxide.

18. The multilayer coating of claim 13, wherein a layer of titanium oxide is deposited by selecting the first precursor or the third precursor from the group of water and titanium tetrachloride, while the second precursor or the fourth precursor are the other from the group of water and titanium tetrachloride, respectively.

19. The multilayer coating of claim 13, wherein a layer of aluminum oxide is deposited by selecting the first precursor or the third precursor from the group of water and trimethylaluminum, while the second precursor or the fourth precursor are the other from the group of water and trimethylaluminum, respectively.

20. The multilayer coating of claim 13, wherein a layer of first material has suitably a thickness of below 25 nanometers and preferably a thickness of below 10 nanometers, and a layer of second material has suitably a thickness of below 25 nanometers and preferably a thickness of below 10 nanometers.

21. The multilayer coating of claim 13, wherein the coating is fabricated at a depositing temperature not more than 150° C.

22. The multilayer coating of claim 13, wherein the coating is fabricated at a depositing temperature not more than 100° C.

23. The multilayer coating of claim 13, wherein the substrate comprises a moisture sensitive device.

24. The multilayer coating of claim 13, wherein the substrate comprises polymer.

25. The multilayer coating of claim 13, wherein titanium oxide and aluminum oxide are in amorphous form.

26. Use of the method of claim 1 to fabricate a multilayer coating on a substrate, to minimize diffusion of water from the environment through the coating onto the surface of the substrate.

27. Use of the multilayer coating of claim 13 on a substrate, to minimize diffusion of water from the environment through the coating onto the surface of the substrate.

28. The use of claim 26, wherein the substrate comprises polymer.

29. The use of claim 26, wherein the substrate comprises a moisture sensitive device.
